(19) United States
(12) Patent Application Publication
(10) Pub. No.: US 2011/0011952 A1
(43) Pub. Date: Jan. 20, 2011

(54) Automated Flow Gun for Delivering Fluids

(75) Inventor: Massimo Gabriele Brusa, Assago (IT)

Correspondence Address: DILWORTH & BARRESE, LLP, 1000 WOODBURY ROAD, SUITE 405, WOODBURY, NY, 11797, US

(73) Assignee: OEMMEBI di Massimo Brusa, Assago (IT)

(21) Appl. No.: 12/834,925

(22) Filed: Jul. 13, 2010

(30) Foreign Application Priority Data
Jul. 14, 2009 (IT) MI2009A001245

(51) Int. Cl. B05B 7/12

(52) U.S. Cl. 239/407

(57) ABSTRACT

An automated flow gun (20) for delivering an abrasive fluid continuously in cleaning and finishing processes of metal pieces, characterized by the presence of a mixing/supply chamber (13) of said fluid and, eventually, the thrust air inside the same gun.

### FIELD OF THE INVENTION

The present invention relates to an automated flow gun suitable for delivering abrasive slurry, particularly used in cleaning and finishing metals.

### BACKGROUND OF THE INVENTION

Products like the device of the present invention already available on the market have the drawback of having to mix the abrasive slurry and the thrust air necessary for spraying outside the same gun. In such manner, inevitably, the whole structure of the spraying system becomes more complex due to the need of using, for example, outer reservoirs for mixing and, at the same time, the spraying operation efficiency decreases since the complexity, and therefore the greater number of involved parts, increases the friction the mixed fluid meets with before exiting the gun nozzle, thus decreasing initial power thereof.

JP 2003 356244 discloses an equipment for performing a planarization of electronic device surfaces by dry ice particle supplied from a blow head comprising a needle valve and a blow nozzle, and

U.S. Pat. No. 3,813,044 shows a metering apparatus for grinding and polishing machines.

### SUMMARY OF THE INVENTION

The automated flow gun according to the present invention is, instead, constituted by a reduced number of parts having small size and being axially assembled, by avoiding shoulders and so as to facilitate a smooth flow of the abrasive slurry and using the spraying power to the maximum. Obviously such design choice is also in favour of the lightness and handling of the final product, as expected. Moreover, for the first rime, the mixture of the abrasive slurry and the thrust air inside the gun together with other technical expedients below disclosed, permits a noticeable delivering duration, which can be actually considered, in respect of the process time, as a continuous delivering.

Main object of the present invention is therefore to provide an automated flow gun which can deliver the abrasive fluid with enough continuity for the whole process of a given mechanical piece.

Another object of the present invention is to provide an automated flow gun in which it is possible to substitute the nozzle with another one having a different spraying angle, so as, for example, not to have to move said gun away from the piece being processed with consequent cost rising due to installation of a handling system.

A further object of the present invention is, then, to provide an automated flow gun constituted by a reduced number of parts, also having small size, so as to control maintenance costs but also, at the same time, the weight.

### BRIEF DESCRIPTION OF THE DRAWINGS

A detailed description of preferred embodiments of the automated flow gun according to the present invention will now be provided with reference to the annexed drawings, in which like referral numbers are used to identify equivalent or identical parts.

FIG. 1 is a longitudinal sectional view of a low pressure automated gun according to a first embodiment of the present invention, and

FIG. 2 is a longitudinal sectional view of a high pressure automated gun according to a second embodiment of the present invention.

### DETAILED DESCRIPTION OF THE PREFERRED EMBODIMENT

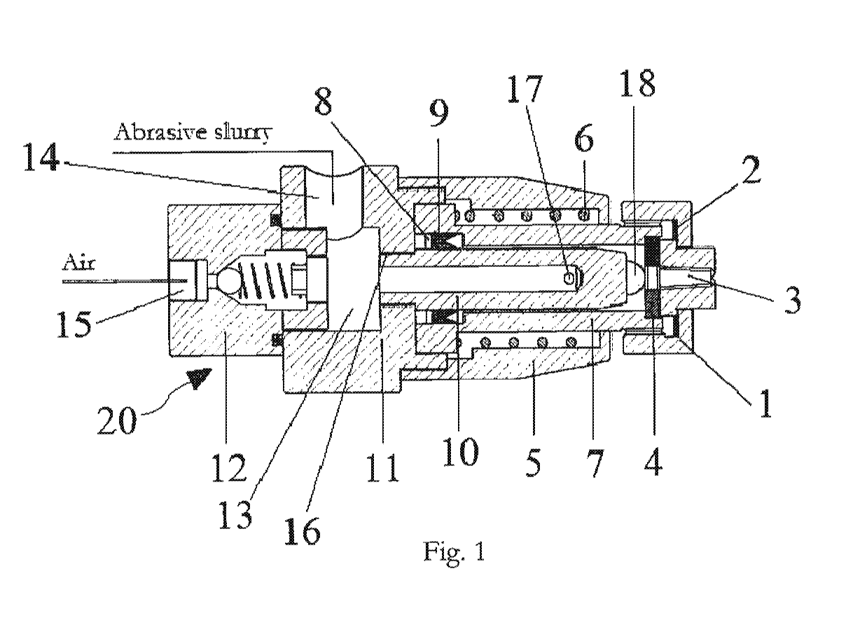

Referring now to FIG. 1, a low pressure automated gun 20 is constituted by a main body 11 provided with an inner cavity or mixing chamber 13. Said chamber 13 communicates outwardly through a first channel 14 for inlet of the abrasive slurry and through a second channel 15 for inlet of thrust air. Upstream of said second channel 15 and communicating with exterior there is a thrust air check valve 12 constituted, as known in the art, by a spring biasing a shutter against an inlet hole of the air coming from a pressure source, such as a compressor. Finally, said mixing chamber 13 has a final channel 16 threaded in order to engage a valve needle 10 constituted by an elongated member internally hollow as well as provided with a through hole 17 for the exit of said valve needle 10 from the inner cavity. In order to enclose said valve needle 10 a pressure tube 7 is mounted by insertion within a suitable seat formed on said main body 11. The seal towards said channel 16 between said pressure tube 7 and said seat is assured by interposing a Seeger ring 8 and a lip gasket 9; in front of the end of said pressure tube 7 opposing said seat there is placed a disc 4, centrally bored and in which a ball 18 integral with the end of said valve needle 10 serving as seat of the same valve is placed. The assembly of the valve needle 10 and the pressure tube 7 is supported by a guard 5 threadingly engaged with said main body 11 and having a return spring 6 around its inner surface. Said spring 6 biases against its seat the pressure tube 7 protruding from said guard 5 enough for forming, on its external surface, a thread for engaging a nozzle-holder cap 1. Between said nozzle-holder cap 1 and said disc 4, a nozzle 3 sealing against said cap 1 by interposition of a flat gasket 2 is fixed.

From the above description it is rather clear also the operating principle laying under the low pressure automated gun 20: the thrust air is supplied inside the mixing chamber 13 at a pressure ranging from 5 to 6 bar on the basis of which the spring of the check valve 12 is dimensioned in order to allow opening thereof; at the same time the abrasive slurry is supplied, always in said mixing chamber 13, by a delivery tube (not shown) which has, at a distance from the mouthpiece of said channel 14 ranging between 50 cm and 150 cm, a check valve (not shown); the mixing of the thrust air and the abrasive slurry occurs inside the chamber 13; the mixed fluid then crosses the inner cavity of the valve needle 10 in order to successively pass, through the through hole 17, into the pressure tube 7; the action of the mixed fluid pressure against the surface of the disc 4 causes the same pressure tube 7 to slide along the axial direction thus freeing the cross-sectional area, that is the central bore of the disc 4, previously being closed by said ball 18; finally the fluid exits the gun 20 through said nozzle 3. The thrust of the mixed and under pressurized fluid is balanced by the spring 6 which returns the pressure tube 7 to its scat at the drop of the pressure under a limit corresponding to the dimensions chosen for said spring 6. It is important to notice that the presence of a check valve on the delivery tube of the abrasive slurry, at the previously described position, allows to deliver the mixed fluid for a continuous delivery time of about 10 seconds, since the section of the delivering tube comprised between said valve and the mouthpiece of the channel 14 actually functions as an accumulator. The delivery continuity allows therefore for fully processing a piece subjected to the spraying action of said low pressure automated gun 20. The type of described assembly further provides for the opportunity of a fast substitution of said nozzle 3 by selecting the most suitable one for the piece being processed: indeed there are provided a plurality of different nozzles on the basis of the inclination angle of the conical longitudinal section within an angle range between 0° and 120°. The particular section of the nozzle 3 allows thus to obtain a conical <<edgewise>> jet having a given height and width which could be even about one meter.

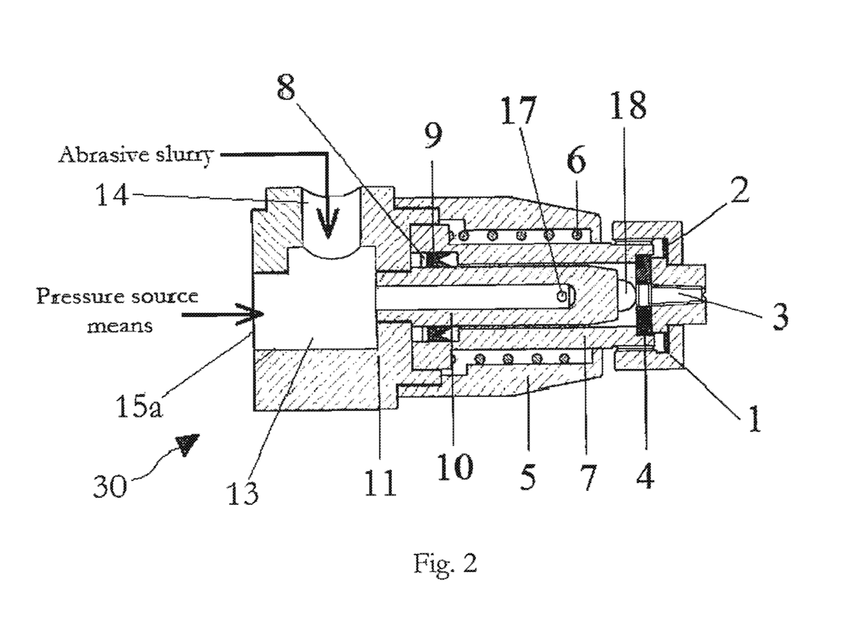

With reference now to FIG. 2, a high pressure automated gun 30 is shown according to a second preferred embodiment of the present invention. Said automated gun 30 provides delivering of abrasive slurry at high pressure, which means that a thrust fluid is no more required since such abrasive slurry is directly pressurized by a pressure source (not shown) according to any prior art pressure source means. Therefore, in respect of the disclosed first embodiment of the low pressure automated gun 20, said high pressure automated gun 30 has only a supply chamber 13 in which abrasive slurry is supplied by a inlet 14 and pressurized, for example, by a piston (not shown) acting through an opening 19b and thrusting said abrasive slurry within the needle valve 10. Such inlet 14 is further provided with a check valve (not shown) thus preventing the abrasive slurry from entering the inlet 14 back. The operation and structure of the high pressure automated gun 30 are, downstream the needle valve 10, the same already disclosed regarding the low pressure automated gun 20 and therefore are herein omitted.

### INDUSTRIAL APPLICABILITY

From the just provided description of the low pressure automated gun, it is clear how the above identified technical problems are overcome and, therefore, how said gun 20 allows a continuous delivering of the abrasive slurry, by a conical edgewise jet in order to make the process of a desired piece efficient and optimal; such results are moreover achieved by a structure of the gun 20 characterized by a reduced number of parts and an extremely simple assembly thus assuring both a reduced weight and a minimal required maintenance. It is finally clear that the automated gun 20 can be used even with other fluid and for different processes, such as for example lubrication, in which case in view of the less aggressiveness of the used fluid in respect of the abrasive one, the disclosed features are further enhanced.

1. An automated flow gun for delivering fluids comprising:
(I) a body provided'with an inner chamber provided with orifices:
(i) for inlet of the pressure thrust fluid,
(ii) for inlet of the pressure working fluid,
(iii) for outlet of the mixed fluid,
(II) a needle valve operatively connected to said outlet orifice and actuated by said mixed fluid for delivering toward
(III) a nozzle
said needle valve comprising:
(iv) an internally hollow valve needle provided with a through-hole in direct communication with
said outlet orifice through said inner chamber,
a pressure tube, through said through-hole, coaxial with said valve needle and slidable thereon,
(v) a guard coaxial with said pressure tube and internally provided with a return spring therefor,
(vi) a bored disc sealed by the end of said valve needle (10) once said spring is in its maximum extension condition.

2. The automated flow gun according to claim 1, wherein said inner chamber is a mixing chamber mixing said thrust fluid and said working fluid.

3. The automated flow gun according to claim 1, wherein said inner chamber is a supply chamber supplied by said working fluid and said thrust fluid is the supplied working fluid pressurized by pressure source provided through said inlet.

4. The automated flow gun according to claim 3, wherein said pressure source is a piston.

5. The automated flow gun according to claim 1, wherein said end of said valve needle is provided with a ball closing said bored disc.

6. The automated flow gun according to claim 2, wherein said nozzle is seated between said bored disc and a cap engaged by screw thread with the outer surface of said pressure tube.
